(19) United States
(12) Patent Application Publication
(10) Pub. No.: US 2008/0250911 A1
(43) Pub. Date: Oct. 16, 2008

(54) Drumsticks

(76) Inventor: Todd Heselton, Frankfort, NY (US)

Correspondence Address: KRAMER & AMADO, P.C., 1725 DUKE STREET, SUITE 240, ALEXANDRIA, VA, 22314, US

(21) Appl. No.: 11/783,763

(22) Filed: Apr. 12, 2007

(51) Int. Cl. G10D 13/02

(52) U.S. Cl. 84/422.4

(57) ABSTRACT

A drumstick for playing a percussion instrument including, in various embodiments and according to various combinations, an elongated member having a striking end, a non-striking end, and two circumferential grooves located on the elongated member, wherein the first circumferential groove is located proximal to the striking end of the drumstick and allows a drummer to spin the drumstick around their finger, and the second circumferential groove is located proximal to the non-striking end allows a drummer to grip the drumstick. In one embodiment the second circumferential groove is located between the non-striking end and ¼ the length of the drumstick measured from the non-striking end.

### BACKGROUND OF THE INVENTION

1. Field of the Invention

This invention relates generally to a drumstick for playing percussion instruments.

2. Background

Drumsticks are used to play a variety of percussion instruments. Drumsticks are traditionally made from various types of wood, often hickory, oak, or maple, though different materials such as fiberglass or carbon fiber can be used. The materials are typically formed into an elongated cylindrical member tapered at one end. This tapered end is sometimes fitted with a bead and is used to strike a percussion instrument. Drumsticks are made in a variety of diameters, lengths, and weights, and are held in a variety of ways, often depending on user preferences or the genre of music to be played.

The objects and advantages described herein are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

While drumsticks are usually made in a standard form, this form has several disadvantages.

A drumstick is usually held between the non-striking end and the bottom third region of the shaft measured from the striking end. This is sometimes considered the optimal region for holding a drumstick because it is believed to allow a drummer to quickly pivot the drumstick back and forth for playing a percussion instrument. Drumsticks are typically made smooth in order to avoid splintering and blistering, however smoothness can lead to problems with controlling the drumstick and maintaining a grip in a desired position. This becomes especially evident with an aggressive style of playing or when a drummer's hands are wet from perspiration.

While a drummer's primary role is the playing of percussion instruments, other aspects of showmanship are sometimes involved. Specifically, many drummers have been known to spin one or both drumsticks around their fingers in order to excite a crowd and increase the feeling of entertainment. When spinning one or both drumsticks, a smooth drumstick has the tendency to slide either up or down the drummer's finger. This sometimes causes the drummer to lose a proper grip on the drumstick or to drop the drumstick completely.

Certain embodiments described herein overcome one or more of the above mentioned problems.

In light of the present need for a drumstick that overcomes one or more of the problems described above, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

Some embodiments separably provide an elongated member having a non-striking end and a tapered striking end for playing a percussion instrument.

Some embodiments separably provide a grip channel including a circumferential groove to enable a drummer to maintain a grip in a desired location.

Some embodiments separably provide a spin channel, including a circumferential groove located between the optimal holding region of the drumstick and the striking end of the drumstick. The circumferential groove enables a drummer to spin a drumstick around their finger with a reduced likelihood of a loss of control of the drumstick.

One or more of these features improve the ability of a drummer to maintain control of a drumstick when playing a percussion instrument or spinning the drumstick for showmanship.

### BRIEF DESCRIPTION OF THE DRAWINGS

In order to better understand various exemplary embodiments, reference is made to the accompanying drawings, wherein:

FIG. 1 shows an elevational view of an exemplary embodiment of a drumstick;

FIG. 2 shows an enlarged view of the spin channel of FIG. 1; and

FIG. 3 shows an enlarged view of the grip channel of FIG. 1.

### DETAILED DESCRIPTION OF THE PREFERRED EMBODIMENTS OF THE INVENTION

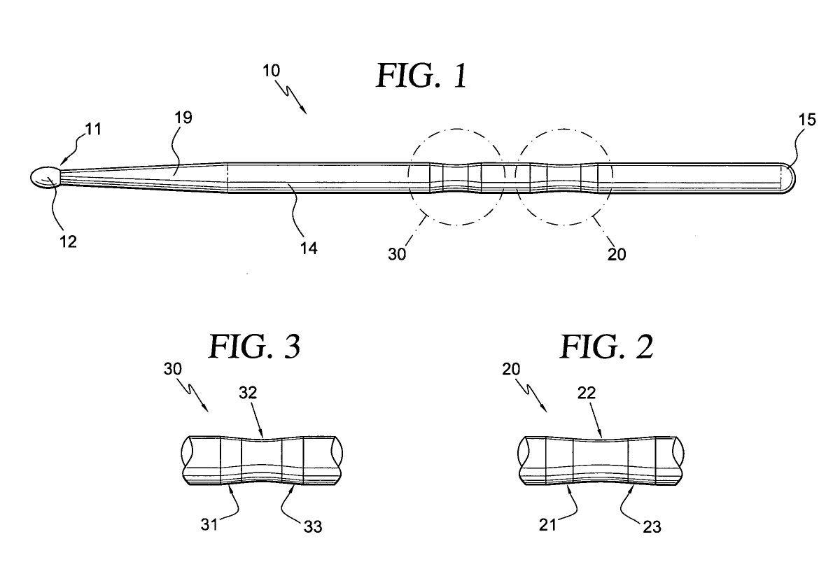

Referring now to the drawings, in which like numerals refer to like components or steps, there are disclosed broad aspects of various exemplary embodiments. FIG. 1 is an elevational view showing an exemplary embodiment of a drumstick 10. The drumstick 10 comprises a striking end 11 having a striking bead 12, however the striking bead 12 is omitted in other embodiments. Adjacent to the striking end 11 is a tapered section 13. Adjacent the tapered section 13, is the shaft 14 of the drumstick 10 ending in the non-striking end 15 or butt of the drumstick 10. The tapered section 13 typically has an increasingly smaller diameter than the shaft 14. Located on the shaft 14 in the depicted embodiment are a grip channel 20 and a spin channel 30, however various embodiments have only one or the other.

FIG. 2 shows an exemplary embodiment of the grip channel 20 in enlarged detail. In the depicted embodiment, grip channel 20 is a circumferential grooved comprised of three different sections 21, 22, 23. It should be apparent that other embodiments have more or less than three sections for the grip channel 20. The different grip channel sections 21, 22, 23 can be formed in a number of ways. They can be shaped to all have one equal radius of curvature, to all have a different radius of curvature, or any combination thereof. In one embodiment the first grip channel section 21 has a first radius of curvature; the second spin channel section 22 has second radius of curvature, greater than the radius of curvature of the first grip channel section 21; and the third grip channel section 23 has a radius of curvature equal to the radius of curvature of the first grip channel section 21.

While the grip channel 20 can be located anywhere on the drumstick, it is believed to be preferable that it be located in the optimal holding region for playing a percussion instrument. This optimal holding region is located from the non-striking end 15 of the drumstick 10 to ¼ the length of the drumstick 10 measured from the non-striking end 15. In one embodiment, the center of the grip channel is located at ¾ the length of the drumstick measured from the striking end. In some embodiments the grip channel is contour cut, molded, lathed or formed into the drumstick in some other manner. The depth of the grip channel can vary from the original circumference to a maximum depth where failure in the drumstick would occur to any shallower depth.

FIG. 3 shows an exemplary embodiment of the spin channel 30 in enlarged detail. In the depicted embodiment, spin channel 30 is a circumferential grooved comprised of three different sections 31, 32, 33. It should be apparent that other embodiments have more or less than three sections for the spin channel 30. The different spin channel sections 31, 32, 33 can be formed in a number of ways. They can be shaped to all have one equal radius of curvature, to all have a different radius of curvature, or any combination thereof. In one embodiment, the first spin channel section 31 has a first radius of curvature; the second spin channel section 32 has second radius of curvature, less than the radius of curvature of the first spin channel section 31; and the third spin channel section 33 has a radius of curvature equal to the radius of curvature of the first spin channel section 31.

While the spin channel 30 can be located anywhere on the drumstick, it is preferable that the spin channel 30 be located between the optimal holding region for playing a percussion instrument and the striking end 11. In one embodiment, the center of the spin channel is located at 1″ past ½ the length of the drumstick measured from the striking end 11. The spin channel can be contour cut, molded, lathed or formed into the drumstick in some other manner. The depth of the spin channel can vary from the original circumference to a maximum depth where failure in the drumstick would occur to any shallower depth.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A drumstick for playing a percussion instrument comprising:
an elongated member having a first striking end and a second non-striking end;
a grip channel located between the first striking end and the second non-striking end; and
a spin channel located between the grip channel and the first striking end, wherein the spin channel and the grip channel are circumferential grooves.

2. The drumstick for playing a percussion instrument according to claim 1, wherein the grip channel has a first grip channel section having a first radius of curvature, a second grip channel section having a second radius of curvature, and a third grip channel section having a third radius of curvature, the first grip channel section being located between the second grip channel section and the striking end, the second grip channel section being between the first grip channel section and the third grip channel section, the third grip channel section being located between the second grip channel section and the non-striking end.

3. The drumstick for playing a percussion instrument according to claim 2, wherein the second radius of curvature is different than the first radius of curvature and the second radius of curvature is different than the third radius of curvature.

4. The drumstick for playing a percussion instrument according to claim 2, wherein the first radius of curvature and the third radius of curvature are the same.

5. The drumstick for playing a percussion instrument according to claim 1, wherein the spin channel has a first spin channel section having a fourth radius of curvature, a second spin channel section having a fifth radius of curvature, and a third spin channel section have a sixth radius of curvature, the first spin channel section being located between the second spin channel section and the striking end, the second spin channel section being located between the first spin channel section and the third spin channel section, and the third spin channel section located between the second spin channel section and the grip channel.

6. The drumstick for playing a percussion instrument according to claim 5, wherein the fifth radius of curvature is different than the fourth radius of curvature and the fifth radius of curvature is different than the sixth radius of curvature.

7. The drumstick for playing a percussion instrument according to claim 5, wherein the fourth radius of curvature and the sixth radius of curvature are the same.

8. The drumstick for playing a percussion instrument according to claim 1, wherein no portion of the spin channel is located at less than ±2 the length of the drumstick measured from the striking end.

9. The drumstick for playing a percussion instrument according to claim 1, wherein the center point of the grip channel is located at ¾ the length of the drumstick measured from the striking end.

10. A drumstick for playing a percussion instrument comprising:
an elongated member having a first striking end and a second non-striking end;
an optimal holding region that extends from the non-striking end to ¼ the length of the drumstick measured from the second non-striking end; and
a spin channel located between the optimal holding region and the first striking end.

11. The drumstick for playing a percussion instrument according to claim 10, further comprising a grip channel located between the spin channel and the second non-striking end.

12. The drumstick for playing a percussion instrument according to claim 11, wherein the spin channel further comprises a first circumferential groove and the grip channel further comprises a second circumferential groove.
